(19) United States
(12) Patent Application Publication
(10) Pub. No.: US 2011/0110101 A1
(43) Pub. Date: May 12, 2011

(54) LED UNIT

(75) Inventors: REN-TAO FU, Shenzhen City (CN); CHIN-CHUNG CHEN, Tu-Cheng (TW)

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/756,972

(22) Filed: Apr. 8, 2010

(30) Foreign Application Priority Data
Nov. 12, 2009 (CN) 200910309637.8

(51) Int. Cl. F21V 5/00

(52) U.S. Cl. 362/311.02

(57) ABSTRACT

An LED unit includes an LED and a lens receiving the LED. The lens includes a pedestal, a light-guiding portion connected to the pedestal and a pair of ears extending outwardly from the pedestal. The light-guiding portion includes a light-incident face facing the LED and a light-emergent face away from the LED. The light-incident face has a constant curvature and the light-emergent has a variable curvature larger than that of the light-incident face.

### BACKGROUND

1. Technical Field

The present disclosure relates to a light emitting diode (LED) unit and, more particularly, to an LED unit having a lens which can produce an effectively converged light beam.

2. Description of Related Art

LEDs, available since the early 1960's and because of their high light-emitting efficiency, have been increasingly used in a variety of occasions, such as residential, traffic, commercial, and industrial occasions. Conventionally, light directly output from the LED does not have a desirable pattern; therefore, a light-adjusting element, such as a lens, is used with the LED to modulate the light pattern thereof.

However, a typical lens generally has a limited light-converging capability; that is, the light passing through the lens cannot be effectively converged to have a small light-emergent angle. Thus, the light pattern output from the lens may have a yellow annulus or shining annulus appearing at a periphery thereof, adversely affecting illumination effect of the LED.

What is needed, therefore, is an LED unit which can overcome the limitations described above.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a lens of an LED unit of the disclosure.

FIG. 2 is an inverted view of the lens of FIG. 1.

FIG. 3 shows a cross-section of the LED unit with the lens of FIG. 1 mounted on an LED module.

### DETAILED DESCRIPTION OF THE EMBODIMENTS

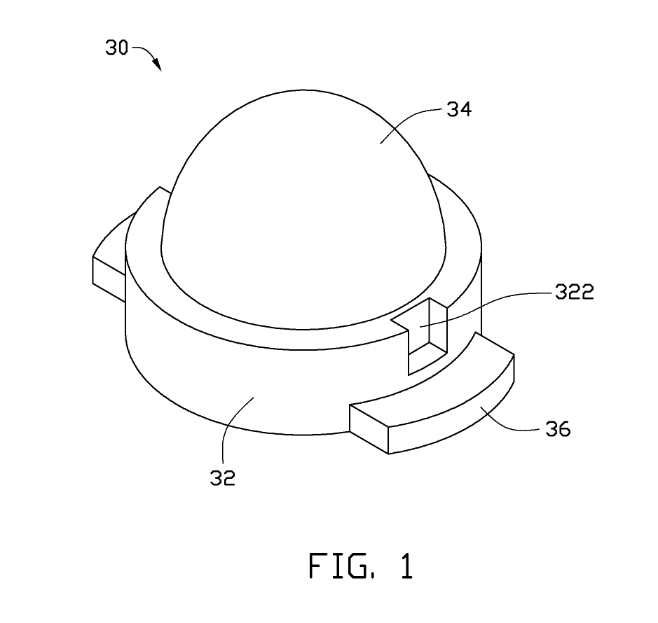

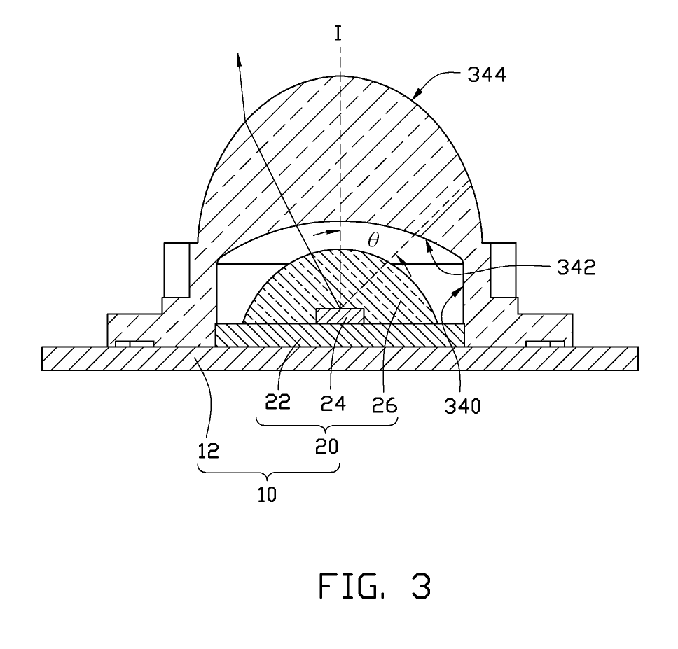

Referring to FIGS. 1 and 3, an LED unit of the present disclosure is illustrated. The LED unit includes an LED module 10 and a lens 30 mounted on the LED module 10. The LED module 10 includes a printed circuit board 12 and an LED 20 mounted on the printed circuit board 12. The printed circuit board 12 may be a MCPCB (Metal Core Printed Circuit Board), a CPCB (Ceramic Printed Circuit Board) or other type PCBs which have good heat dissipation capability. The LED 20 includes a heat-conducting base 22, an LED die 24 mounted on a top of the base 22, and an encapsulant 26 covering the LED die 24 and fixed on the top of the base 22. The base 22 of the LED 20 is soldered on the printed circuit board 12 to conduct heat generated by the LED die 24 to the printed circuit board 12. In addition, the LED die 24 is electrically connected with the printed circuit board 12 via the base 22. The LED die 24 may be an InGaN chip, an InGaAs chip, a GaP chip or other suitable chips which could generate visible light with a desirable color. The encapsulant 26 is made by epoxy, silicon, glass or other transparent materials which have good light-permeable and water-proof capabilities. Phosphor, often in the form of particulates, may be doped within the encapsulant 26 to adjust the color of the light emitted from the LED die 24. The encapsulant 26 is shaped like a dome so as to collimate the light from the LED die 24 into a converged beam. The encapsulant 26 is spaced from the lens by air. The LED 20 has an optical axis I, around which the light emitted from the encapsulant 26 is symmetrical in a surrounding space.

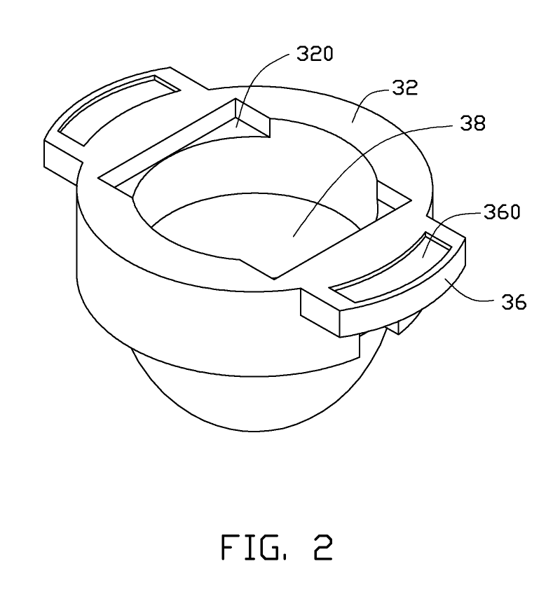

Also referring to FIG. 2, the lens 30 is made from transparent materials such as PC (polycarbonate) or PMMA (polymethyl methacrylate). The lens 30 includes a pedestal 32, a pair of ears 36 extending outwardly from a periphery of the pedestal 32 and a light-guiding portion 34 extending upwardly from the pedestal 32. The pedestal 32 has a circular configuration with a rectangular opening 320 defined in a bottom face thereof. The opening 320 has an area similar to that of the base 22 of the LED 20 so that the base 22 of the LED 20 could be engagingly received in the opening 320. A circular cavity 38 is defined in an interior of the lens 30. The cavity 38 is located at a center of the opening 320. The cavity 38 communicates with the opening 320 to receive the encapsulant 26 of the LED 20 therein. The light-guiding portion 34 has a largest thickness at the optical axis and a smallest thickness at an outmost periphery thereof. An inner face of the lens 30 confronting the LED 20 is employed as a light-incident face 342 of the lens 30. The light-incident 342 is concaved upwardly to form a dome above the LED 20. The light-incident face 342 has a constant curvature selected from 0.11 mm⁻¹˜0.14 mm⁻¹, wherein a value of 0.12 mm⁻¹ is preferable in this disclosure. Another inner face 340 of the lens 30 surrounds the LED 20 and connects with the light-incident face 342. The another inner face 340 of the lens 30 is flat and perpendicular to the base 22 of the LED 20. An outer face of the light-guiding portion 34 is employed as a light-emergent face 344 of the lens 30. The light-emergent face 344 is protruded upwardly to have a dome shape. The light-emergent face 344 has a varied curvature ranging between 0.12 mm⁻¹ and 0.24 mm⁻¹. An angle θ, which is defined between an arbitrary line and the optical axis I as shown in FIG. 3, is introduced in order to illustrate the changing trend of the curvature of the light-emergent face 344. As the angle θ increases from zero, the curvature of the light-emergent face 344 gradually increases from the minimum value of 0.12 mm⁻¹. While the angle θ increases to reach a predetermined value (preferably 70% of the maximum value of the angle θ), the increasing trend of the curvature of the light-emergent face 344 is reversed and the curvature of the light-emergent face 344 begins to decrease. As the angle θ keeps increasing to reach 90% of the maximum value of the angle θ, the decreasing trend of the curvature is reversed again and the curvature of the light-emergent face 344 starts to increase again until reaching the maximum value of 0.24 mm⁻¹. That is to say, a chart of the curvature of the light-emergent face 344 plotted on a Cartesian coordinate system with the angle θ on the X-axis has a shape of a wave.

The pair of ears 36 are extended towards opposite directions from the periphery of the pedestal 32, respectively. Each ear 36 has a bottom leveling with the bottom of the pedestal 32 and a top lower than a top of the pedestal 32. A groove 360 is defined in the bottom of each ear 36 for receiving adhesive material so as to fix the lens 30 on the printed circuit board 12. A pair of cutouts 322 are defined in a periphery of the top of the pedestal 32 and located above the pair of ears 36, to thereby indicate the proper mounting orientation of the lens 30 when assembling the lens 30 on the printed circuit board 12.

As being refracted by the light-incident face 342 and the light-emergent face 344 in sequence, the light output from the lens 30 can have a small emergent angle. Therefore, the light pattern produced by the LED unit does not have yellow or shining annulus appearing at a periphery thereof.

It is believed that the present disclosure and its advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. An LED unit comprising:
an LED having an optical axis; and
a lens comprising a light-guiding portion, the light-guiding portion comprising a light-incident face confronting the LED and a light-emergent face remote from the LED;
wherein the light-emergent face has a curvature larger than that of the light-incident face; and
wherein the curvature of the light-emergent face is varied at different positions of the light-emergent face.

2. The LED unit as claimed in claim 1, wherein the curvature of the light-emergent face ranges between 0.12 mm⁻¹ and 0.24 mm⁻¹.

3. The LED unit as claimed in claim 2, wherein the curvature of the light-emergent face is smallest at the optical axis and largest at a periphery of the light-emergent face.

4. The LED unit as claimed in claim 3, wherein the curvature of the light-emergent face firstly increases then decreases and then increases again along a direction away from the optical axis.

5. The LED unit as claimed in claim 1, wherein the light-incident face has a constant curvature.

6. The LED unit as claimed in claim 5, wherein the curvature of the light-incident face is selected from 0.11 mm⁻¹ to 0.14 mm⁻¹.

7. The LED unit as claimed in claim 1, wherein the lens comprises a flat inner face connected to the light-incident face and surrounding the LED.

8. The LED unit as claimed in claim 1, wherein the light-emergent face is protruded away from the LED.

9. The LED unit as claimed in claim 8, wherein the light-incident face is concaved away from the LED.

10. The LED unit as claimed in claim 9, wherein a distance between the light-incident face and the light-emergent face is largest at the optical axis and smallest at a periphery of the light-guiding portion.

11. The LED unit as claimed in claim 1, wherein the lens further comprises a pedestal connected to the light-guiding portion, a hole being defined in the pedestal to receive the LED.

12. The LED unit as claimed in claim 11, wherein the lens further comprises a pair of ears extending outwardly from a periphery of the pedestal.

13. The LED unit as claimed in claim 12, wherein each of the ears has a groove defined therein, the groove being spaced from the hole in the pedestal.

14. The LED unit as claimed in claim 13, wherein the LED is mounted on a printed circuit board, the lens being fixed on the printed circuit board.

15. The LED unit as claimed in claim 14, wherein the groove of each of the ears is filled with adhesive material bonded to the printed circuit board.

16. The LED unit as claimed in claim 12, wherein a pair of cutouts are defined in the periphery of the pedestal over the pair of ears, respectively.
